(19) United States
(12) Patent Application Publication
(10) Pub. No.: US 2026/0221317 A1
(43) Pub. Date: Jul. 30, 2026

(54) COAXIAL DUAL CORE HIGH-VOLTAGE CABLE AND METHOD FOR MANUFACTURING THE COAXIAL DUAL CORE HIGH VOLTAGE CABLE

(71) Applicant: HYDRO EXTRUDED SOLUTIONS AS, Oslo (NO)

(72) Inventors: Henrik JØRGENSEN, Grasten (DK); Torben THOMSEN, Krusaa (DK); Preben H. GAUL, Tønder (DK)

(73) Assignee: HYDRO EXTRUDED SOLUTIONS AS, Oslo (NO)

(21) Appl. No.: 19/141,783

(22) PCT Filed: Dec. 21, 2023
(86) PCT No.: PCT/EP2023/087395

§ 371 Date: Jun. 20, 2025

(30) Foreign Application Priority Data
Dec. 22, 2022 (NO) 20221399

(51) Int. Cl. H01B 7/42; H01B 9/02; H01B 13/016

(52) U.S. Cl. CPC H01B 7/423; H01B 9/02; H01B 13/016

(57) ABSTRACT

The present disclosure relates to a coaxial dual core high-voltage (HV) cable, comprising a first extruded, elongated hollow profile of an electrically conducting metal, forming a first conductor, a second extruded, elongated profile of an electrically conducting metal, forming a second conductor, where the second conductor is arranged coaxially inside the first conductor. A first electrically insulating layer is arranged between the first conductor and the second conductor, and coating the outer surface of the second conductor and the inner surface the first conductor, and a second electrically insulating layer is coating the outer surface of the first conductor. The present disclosure also relates to a method for manufacturing and the application such cable.

### TECHNICAL FIELD

The present application relates to an internally and/or externally cooled coaxial dual core high-voltage cable, and a method of manufacture of the said cable. The application also relates to coaxial dual core flat formed high-voltage cable which is externally and/or internally cooled, and a method of manufacture of the said flat formed cable. The coaxial dual core high-voltage cable of the present disclosure is especially suitable for use in vehicles, such as electrical vehicles and hybrid electrical vehicles.

### BACKGROUND ART

High-voltage (HV) cables for electric power transmission at high voltage are used in various applications, such as ignition systems and alternating current (AC) or direct current (DC) power transmission. HV cables are also used in the field of hybrid electric vehicle (HEV) or electric vehicle (EV) technology, where voltage power from the battery is amplified by an inverter and output to the drive motor via a large-diameter, high-voltage power cable with sufficient current capacity.

The demands on and development within hybrid electric vehicle and electric vehicle technology has led to an increase in the size of HV cables used as power cables due to the higher voltage in the power transmission. At high voltage the conducting material tends to become very hot unless the cable has a sufficiently high diameter. There is also a continuous strive to reduce the size of the engine room and to decrease the weight of all components in vehicles. Therefore, there is a need for HV cables that allow reduced size and weight of the components in the vehicle.

### SUMMARY OF INVENTION

An object of the present invention is to provide a high-voltage cable which is light weight and space saving.

The object is achieved by the subject-matter of the appended independent claim(s).

According to a first aspect the present disclosure relates to a coaxial dual core high-voltage (HV) cable, comprising a first extruded, elongated hollow profile of an electrically conducting metal, forming a first conductor, a second extruded, elongated profile of an electrically conducting metal, forming a second conductor, where the second conductor is arranged coaxially inside the first conductor, and further a first electrically insulating layer which is arranged between the first conductor and the second conductor, and coating the outer surface of the second conductor and the inner surface the first conductor, and where a second electrically insulating layer is coating the outer surface of the first conductor.

The second conductor may either be a solid rod, or a hollow profile having at least one void throughout its total length.

The coaxial dual core HV cable may have a cross-sectional shape selected from circular, rounded, oval, flattened oval (stadium shaped), rectangular, oblong, quadratic, or polygonal.

The coaxial dual core HV cable may have a flat cross-sectional shape, where the first electrically insulting layer arranged between the first conductor and the second conductor is in direct contact with the outer surface of the second conductor and the inner surface the first conductor, and where the first electrically insulting layer has a substantially uniform thickness.

The coaxial dual core HV cable may further comprise at least one cooling channel for flow of a cooling medium, where the at least one cooling channel is an extruded metal tube which is coaxially arranged inside the at least one void of the second conductor, and a third electrically insulating layer is arranged between the outer surface of the at least one cooling tube and the inner surface of the at least one void of the second conductor.

The coaxial dual core HV cable may comprise two cooling channels where the cooling channels are a first cooling channel for flow of a cooling medium, and a second cooling channel for a return flow of the cooling medium.

The two cooling channels may be formed by a single extruded cooling tube which has two parallel channels extending in the axial direction.

Two cooling channels may be formed by two separate extruded tubes extending in the axial direction.

The first conductor and the second conductor and the at least one cooling tube(s) are made of a metal chosen from aluminium, aluminium alloy, copper or copper alloy. Preferably the first conductor, the second conductor and the at least one cooling tube(s) are made from aluminium or aluminium alloy.

In a preferred embodiment, the first conductor and/or the second conductor are made of an AA6XXX-series alloy or an AA1XXX-series alloy.

The material of the first electrically insulating layer, and/or the second electrically insulating layer, and/or the third electrically insulating layer may have a dielectric strength of 30-70 kV/mm.

The material of the second electrically insulating layer may have a dielectric strength of 15-30 kV/mm.

According to a second aspect the present disclosure relates to a method for manufacturing the coaxial dual core high-voltage cable described above. The method comprises the steps of
(i) providing a first extruded hollow profile of an electrically conducting metal, and a second extruded profile of an electrically conducting metal, the second extruded profile is having a diameter which is smaller than the internal diameter of the hollow of the first extruded hollow profile, and the second extruded profile is either a solid rod, or a hollow profile having at least one void throughout its total length;
(ii) applying a coating layer of a first electrically insulating material onto the outer surface of the second extruded profile, to obtain a coated second extruded profile having a first electrically insulating layer;
(iii) assembling the first extruded hollow profile and the second extruded profile by placing the coated second extruded profile inside the first extruded hollow profile and
   (a) expanding the coated second extruded tube until the first electrically insulating layer is directly contacting and covering the inner surface of the first extruded hollow profile, or
   (b) reducing the diameter of the cross-section of the first extruded hollow profile until the first electrically insulating layer is directly contacting and covering the inner surface of the first extruded hollow profile, or
   (c) a combination of both (a) and (b); and
(iv) applying a coating layer of a second electrically insulating material onto an outer surface of the first extruded hollow profile.

The method may comprise applying the second electrically insulating layer before or after step (iii).

The method may further comprise,
providing at least one cooling tube, where the at least cooling tube is an extruded metal tube;
applying a coating layer of a third electrically insulating material onto the outer surface of the at least one cooling tube, to obtain at least one coated cooling tube;
placing the at least one coated cooling tube inside the second extruded hollow profile having at least one void, and performing one or both of
   expanding the at least one coated cooling tube until the third electrically insulating layer on the outer surface of the at least one cooling tube is in direct contact with and covering the inner surface of the void of the second extruded hollow profile, or
   reducing the diameter of the cross-section of the second extruded hollow profile until the third electrically insulating layer on the outer surface of the at least one cooling tube is in direct contact with and covering the inner surface of the void of the second extruded hollow profile.

The method may further comprise a step of flattening the cable.

The first extruded hollow profile, the second extruded profile, and the at least one cooling tube(s) are made of a metal chosen from aluminium, aluminium alloy, copper or copper alloy, preferably aluminium or aluminium alloy.

According to a third aspect the present disclosure relates to the use of the coaxial dual core high-voltage (HV) cable described above, for electric power transmission at high voltage in a hybrid electric vehicle (HEV), or in an electric vehicle (EV), or as a charging cable in a charging unit or a charging station, or in charging station infrastructure, or in an electrical vessel or hybrid electrical vessel, or in a data centre, or in windmills or windmill parks, or in PV systems.

### BRIEF DESCRIPTION OF DRAWINGS

FIG. 1a illustrates a perspective view of a part of a coaxial dual core HV cable according to the present disclosure. Different layers of the cable are shown for illustrative purpose.

FIG. 1b illustrates a side view of the part of the coaxial dual core HV cable in FIG. 1a.

FIG. 1c illustrates a cross-section view of the coaxial dual core HV cable in FIGS. 1a and 1b.

FIG. 2 illustrates a perspective view of a part of a flat formed coaxial dual core HV cable according to the present disclosure.

FIG. 3 illustrates a cross-section shape of a part of a flat coaxial dual core HV cable according to the present disclosure.

FIG. 4a-c illustrates perspective views of parts of different example embodiments of the coaxial dual core HV cable according to the present disclosure having internal cooling channels.

FIG. 5 illustrates a cross-section of a flat formed coaxial dual core HV cable according to the present disclosure having an internal cooling channel.

### DETAILED DESCRIPTION

In the following description, various examples and embodiments of the invention are set forth to provide the skilled person with a more thorough understanding of the invention. The specific details described in the context of the various embodiments and with reference to the attached drawings are not intended to be construed as limitations. Rather, the scope of the invention is defined in the appended claims.

Throughout the description and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a”, “an”, and “the” may include plural references. The meaning of “in” includes “in” and includes plural references. The meaning of “in” includes “in” and “on”.

The present disclosure aims at providing a coaxial dual core high-voltage cable (hereafter also denoted “cable”) which is light weight and space saving. The described cable is suitable for applications where the voltage is from 600-1200 V, e.g. in electrical vehicles, however the cable can be used with other voltage ranges, e.g. up to 2500 V and even higher. The cable has excellent inner and/or outer cooling, thus avoiding heat build-up in the cable core. The cable is especially suitable for installation in electrical vehicles or hybrid electrical vehicles. The cable is also suitable to be connected to a charging cable in a charging unit or charging station, or for use in charging station infrastructure. Other suitable applications of the cable are electrical vessels or hybrid electrical vessels, such as marine vessels, ships and boats, data centres, windmills, PV systems, and any other installations requiring HV transfer cables.

Accordingly, the present disclosure relates to a coaxial dual core high-voltage (HV) cable, comprising a first extruded, elongated hollow profile of an electrically conducting metal, which forms a first conductor (also denoted “outer conductor”), a second extruded, elongated profile of an electrically conducting metal, which forms a second conductor (also denoted “inner conductor”), wherein the second conductor is arranged coaxially inside the first conductor, and a first electrically insulating layer is securely arranged between the first conductor and the second conductor, coating the outer surface of the second conductor and the inner surface the first conductor, and a second electrically insulating layer/sheath is coating the outer surface of the first conductor. The provision of the first electrically insulating layer firmly fixed between the inner conductor and the outer conductor, directly contacting the entire surface area of the adjacent inner and outer conductors, results in a large surface contact area and an excellent heat transfer between the inner conductor and the outer conductor. Furthermore, the first electrically insulating layer arranged between the inner conductor and the outer conductor is firmly held in place thus allowing bending of the cable without compromising the heat transfer capabilities or the insulating properties. In addition, thanks to the concentric conductors, the coaxial dual core HV cable does not require shielding or filters to minimize electromagnetic interference. The enhanced cooling and the eliminated need for a shielding layer allow for smaller cable cross-section area compared to the high-voltage application and capacity.

The expression “direct contact” or “directly contacting”, or the like as used herein, concerning the first electrically insulating layer arranged between the inner (second) conductor and the outer (first) conductor, should be understood as the first electrically insulating layer is contacting and covering the full inner surface of the first (outer) conductor and the outer surface of the second (inner) conductor, preferably without any gaps therebetween, including after any bending operations. It should be understood that the same applies to the disclosure concerning the third electrically insulating layer arranged between the at least one cooling tube(s) and the inner conductor.

The electrically conducting metal forming the outer (first) and the inner (second) conductors may be chosen from aluminium, aluminium alloy, copper, or copper alloy. It is preferred that the electrically conducting metal is aluminium or aluminium alloy as aluminium will significantly reduce the weight of the cable compared with Cu. In addition, aluminium has lower cost compared with Cu, and may also be a more sustainable choice of material. Particularly suitable aluminium alloys for the inner and outer conductors are AA6XXX-series aluminium alloys and AA1XXX-series aluminium alloys. In the present disclosure, reference to AA1XXX and AA6XXX-series aluminium alloys refer to the nomenclature of the Aluminum Association which uses a four-digit system for wrought alloy composition families (ref. “International Alloy Designations and Chemical Composition Limits for Wrought Aluminum and Wrought Aluminum Alloys”, by The Aluminum Association, Inc).

The coaxial dual core HV cable may have a substantially circular, rounded, oval, flattened oval (stadium or pill shape), rectangular, oblong, quadratic, or polygonal cross-sectional shape. A general flat shape of the cable is advantageous because a large surface area of the flat cable results in a better heat dissipation (external cooling, “passive” cooling) compared with a round or non-flat cable. A flat cable may therefore allow reduction in both the volume and the total weight of cables. A general flat shape is also advantageous with regards to placing and stacking of the cables since less space is required.

The first electrically insulating layer is made of a non-electrically conductive material that is suitably capable of withstanding bending and suitably has a sufficient dielectric strength, preventing current passing between the inner and outer conductors. The material of the first electrically insulating layer preferably has a dielectric strength of 30-70 kV/mm, more preferably at least 40 kV/mm. Thereby, the first electrically insulating layer can be made relatively thin to allow efficient heat transfer from the inner conductor, while at the same time provide sufficient electrical insulation. The material of the first electrically insulating layer may be a polymeric material, for example a polyethylene or a polyamide, such as PA12 or the like, which has sufficient dielectric strength and therefore can be made thin enough to provide efficient heat transfer from the inner conductor to the outer conductor. Other advantageous properties of the first electrically insulating layer material are good adhesion properties and flame retardancy and good thermal conductivity.

It is important to avoid short circuit and damage to equipment and people. Therefore, the first electrically insulating layer should preferably cover and be in contact with the entire surface of the outside of the inner conductor without any gaps, and preferably also be in contact with the entire inner surface of the outer conductor. It should be understood that a portion of the ends of the inner conductor may not be covered by the electrically insulating layer to allow electrically connection to a connection point. Advantageously, the first electrically insulating layer is first applied to the inner conductor, which is then inserted into the outer conductor and thereafter the inner conductor is expanded, or alternatively the diameter of the cross-section of the outer conductor is reduced, as will be explained in more detail below. The material of the electrically insulating layer may be applied so as to obtain permanent adhesion between the inner conductor and the insulating layer, such as chemical adhesion, e.g. by applying a primer or glue to the surface of the inner conductor before applying the insulating layer, or any other suitable pre-treatment.

High-voltage cables need to be outwardly insulated to prevent contact of conductor with other objects or people. The cable therefore comprises a second electrically insulating layer arranged on the outside surface of the outer conductor, preventing undesired short circuit and other damage. The material of the second electrically insulating layer is suitably a non-conductive polymeric material, and may have a lower dielectric strength than the material of the first electrically insulating layer, such as e.g. 15-30 kV/mm, or 20-25 kV/mm. The material of the second electrically insulating layer may have a higher dielectric strength, e.g. the material of the second electrically insulating layer may be the same as the first insulating layer. The requirement for good heat transfer may not be so high on the conductor outside, and the second electrically insulating layer may therefore have a higher material thickness than the first electrically insulating layer. For example, the second electrically insulating layer may be made of a polymeric material, such as polyethylene, such as XLPE, which has a considerably lower cost than materials having higher dielectric strength. The second electrically insulating layer is preferably not permanently adhered to the surface of the conductor, in order to allow it to be peeled off for electrical connecting purposes.

The ends of the inner and outer conductors may be shaped to form separate connections. In a preferred embodiment the connections are integrated with the conductors of the cable.

According to a first embodiment, the coaxial dual core HV cable according to the present disclosure has a flat cross-sectional shape. A flat shape of the cable cross-section is advantageous since the flat form provides better heat dissipation due to the large surface area in relation to the cross-sectional area of the conductors. A flat cable may have a cross-section that has a substantially oblong, oval or a flat oval shape (stadium shape). The term “flat” should be understood to include cable cross-section shapes where the ratio of the transversal direction (width w) to the height h is more than 1. The w/h ratio should preferably be at least 1.5, or at least 2, such as 2-8, or 4-7. The outer conductor (first conductor) is comprised of an elongated hollow extruded profile (first extruded profile). The inner conductor may be comprised of a solid or a hollow extruded profile (second extruded profile). The cross-sectional shapes of the first and second extruded profiles should preferably correspond such that the second extruded profile fits within the longitudinal hollow of the first extruded profile, and the first electrically insulating layer arranged between the two profiles is fully covering and locked in place by outer surface of the inner conductor and the internal surface of the outer conductor. Furthermore, the first electrically insulating layer is substantially uniform in its thickness over the entire length in a straight cable. The flat cable shape may be obtained by flattening the assembly of the inner conductor and the outer conductor, having the insulating layer arranged therebetween. The flattening may be obtained by rolling, pressing, drawing or any other suitable method. In an embodiment the inner conductor is made of an extruded hollow profile having a cross-sectional shape corresponding with the outer conductor. This embodiment may facilitate the manufacturing of the conductor assembly, and the flattening process. By the flattening process the inner conductor may obtain a strip-like shape as the hollow profile is compressed. The flat cable comprises an insulating layer/sheath on the outer surface of the outer conductor. The outer insulating layer/sheath can be applied before or after the flattening of the conductor assembly.

It should be understood that the coaxial dual core HV cable may have a flat shape on one or more portions of the longitudinal length of the cable, hence the cross-sectional shape of the cable may vary along the longitudinal length. Different cross-sectional shapes along the length of the cable may be advantageous to facilitate placement and installation of the cable.

The electrically conducting metal for the outer and inner conductor, the first electrically insulating material, and the second insulating material according to the first embodiment, corresponds with the same as described above.

In a second embodiment the coaxial dual core HV cable according to the present disclosure may comprise at least one internal cooling channel for passing a cooling medium through the interior of the cable, thereby effecting cooling of the cable. In this second embodiment the inner (second) conductor is comprised of an extruded, elongated hollow profile having at least one hollow void throughout the length. The outer (first) conductor is comprised of an extruded hollow elongated profile, as described above. A first electrically insulating layer is arranged between the inner and outer conductors, fully covering the outer surface of the inner conductor and the internal surface of the outer conductor, in a corresponding way as explained above. The first insulating layer is substantially uniform in its thickness and is firmly held in place by the inner and outer conductors. The at least one cooling channel is arranged in the at least one void of the inner (second) conductor, extending in the longitudinal direction of the cable. An electrically insulating layer, herein denoted a third electrically insulating layer, is arranged between the outer surface of the at least one cooling channel and the inner surface of the void of the hollow inner conductor.

The at least one cooling channel (also denoted cooling tube herein) is preferably made of an extruded metal tube due to the excellent heat transfer properties and the non-permeability for gas and liquids in metals. The cooling tube may advantageously be made of aluminium, an aluminium alloy, copper or a copper alloy. Due to the low weight and relatively low cost of aluminium and aluminium alloys, as compared to copper, it is preferred that the at least one cooling tube is made of aluminium or an aluminium alloy. Suitable aluminium alloys for the cooling tube may be for example AA3XXX-series alloys, e.g. AA3003. The alloy used for the cooling tube should preferably have good drawability. The alloy should preferably also have an acceptable corrosion resistance.

The at least one cooling channel may be an extruded aluminium tube having two channels, or at least two channels, running parallel in the longitudinal direction, in which channels the cooling medium may flow in the same or opposite directions. Alternatively, the at least two cooling channels may be comprised of two or more cooling tubes arranged within the inner conductor flowing the cooling medium in the same or opposite directions. In the example of two separate cooling tubes, the inner conductor may have two longitudinal hollows extending throughout the length of the profile to accommodate the cooling tubes. A single cooling tube having two channels, or two separate cooling tubes, enable use of a single coupling for supplying and collecting the cooling fluid/medium as the cooling fluid may be introduced and exited from the same end of the cable. In such embodiment the opposite end of the cooling channels may be closed by a capping device for directing the flow of cooling medium from the inlet channel into the return channel. The at least one cooling channel may have a length that is greater than the inner and outer conductors. Furthermore, the at least one cooling channel may be equipped with means or shaped in a way that allows quick coupling of cooling medium/fluid to the cooling tube(s). It is preferred that the outer surface of the at least one cooling channel extending from the cable is completely covered/insulated by the third electrically insulating layer, or other suitable insulating cover.

The third electrically insulating layer is made of a non-electrically conductive material that is suitably capable of withstanding bending and suitably has a sufficient dielectric strength, preventing current passing between the at least one cooling channel and inner conductor. The material of the third electrically insulating layer may have a dielectric strength of 30-70 kV/mm, preferably at least 40 kV/mm. Thereby, the third electrically insulating layer can be made relatively thin to allow efficient cooling of the inner and outer conductors, while at the same time provide sufficient electrical insulation. The material of the third electrically insulating layer may be a polymeric material, for example a polyethylene, or a polyamide, such as PA12 or the like, which has sufficient dielectric strength and therefore can be made thin enough to provide efficient cooling of the coaxial dual core HV cable. The third electrically insulating layer should preferably cover and be in contact with the entire surface of the outside of the at least one cooling channel without any gaps, and preferably also be in contact with the entire inner surface of the inner conductor. Other advantageous properties of the third electrically insulating layer material are good adhesion properties and flame retardancy and good thermal conductivity.

Advantageously, the third electrically insulating layer is first applied to the at least one cooling tube, before being inserted into the hollow of the inner conductor and thereafter the at least one cooling tube is expanded, or alternatively the inner conductor is reduced in cross-section, as will be explained in more detail below. The material of the third electrically insulating layer may be applied so as to obtain permanent adhesion between the cooling tube and the insulating layer, such as chemical adhesion, e.g. by applying a primer or glue to the surface of the cooling tube before applying the insulating layer, or any other suitable pre-treatment.

The high-voltage dual core cable of the present disclosure can have a smaller cross-sectional area than a solid non-cooled high-voltage cable for a corresponding voltage application, due to the enhanced outer cooling and/or the interior cooling. Accordingly, with any of the constructions or configurations as defined above, the cable may have a cross-sectional area of e.g. 70-500 mm². As an example, an externally or internally cooled cable having a cross-section area of 70-120 mm², would correspond to a solid cable having a cross-sectional area of around 200-250 mm² for the same voltage application. The cooling tube(s) may suitably have an outer diameter of 6-10 mm. Due to the small diameter and the interior space, the cost and weight can be considerably reduced. It should be understood that other cross-sectional areas and dimensions can be realized for different applications. In the present context, the cable cross-section area refers to the cross-sectional area of the conductors.

A typical operating environment temperature may be around 125° C.

The high-voltage cable of the present disclosure may typically not be flexible, due to the preferred choices of extruded metal profiles for use as the inner cooling tube(s), and the conductors. The cable may therefore need to be bent to its final shape using bending tools.

The present disclosure further relates to a method for manufacturing the coaxial dual core high-voltage cable described above. The method comprises the steps of:
providing a first elongated extruded hollow profile of an electrically conducting metal, and a second elongated extruded profile of an electrically conducting metal, where the second extruded profile has an outer diameter which is smaller than the inner diameter of the hollow of the first extruded hollow profile, and the second extruded profile (3) is either a solid rod, or a hollow profile having at least one void throughout its total length;
applying a coating layer of a first electrically insulating material onto the outer surface of the second extruded profile to obtain a coated second extruded profile having a first electrically insulating layer thereon;
placing the coated second extruded profile inside the hollow of the first extruded hollow profile and either
   (i) expanding the coated second extruded profile until the first electrically insulating layer is completely covering the inner surface of the first extruded hollow profile, or
   (ii) reducing the cross-section of the first extruded hollow profile until the first electrically insulating layer is completely covering the inner surface of the first extruded hollow profile;
   (iii) or a combination of the methods (i) and (ii), and
applying a coating layer of a second electrically insulating material onto the outer surface of the first extruded hollow profile.

The reduction of the cross-section of the hollow profile may be performed by cold working such as hammering, pressing, roll forming, drawing or other method know to the person skilled in the art.

The second extruded profile may be a solid profile or a hollow profile having at least one void throughout the length. The cross-sectional shape of the first extruded hollow profile, especially the cross-sectional shape of the longitudinal hollow void of the first extruded hollow profile, should preferably correspond with the outer cross-sectional shape of the second extruded profile. By having corresponding cross-sectional shapes of the first and second profiles the assembly of the extruded profiles will be facilitated.

The first electrically insulating layer may be applied on the outer surface of the second extruded profile by any suitable method, e.g. co-extrusion, powder coating, using adhesion or other method known to the skilled person. The material of the first electrically insulating layer may be applied so as to obtain permanent adhesion between the inner conductor and the insulating layer, such as chemical adhesion, e.g. by applying a primer or glue to the surface of the inner conductor before applying the insulating layer, or any other suitable pre-treatment. It should be understood that a portion of one or both ends of the inner conductor may be uncoated for electrically connection.

The second electrically insulating layer may be applied onto the outer surface of the first extruded profile by any suitable method, which may correspond to the method described above for applying the first electrically insulating layer. Thus, the method of applying the second electrically insulating layer may involve co-extrusion, powder coating, or other suitable methods. The application of the second insulating layer onto the outer surface of the first extruded hollow profile may be done before or after the assembly of the first extruded hollow profile and the second extruded profile.

The assembly of the first and second extruded profiles includes placing the coated second extruded profile inside the longitudinal hollow of the first extruded hollow profile. Thereafter, at least one of the profiles is deformed such that the first electrically insulation layer is firmly in contact with the inner surface of the first extruded hollow profile (the outer conductor) as well as the outer surface of the second extruded profile (the inner conductor). If the coated second extruded profile is a hollow profile, the deformation can be obtained by expanding the coated second extruded profile until the first electrically insulating layer is completely and firmly contacting and covering the inner surface of the first extruded hollow profile. Expansion of the profile may be accomplished by methods known to the skilled person, e.g. plug drawing and hydroforming. Alternatively, the deformation can be obtained by reducing the cross-section of the first extruded hollow profile until the first electrically insulating layer is completely and firmly contacting and covering the inner surface of the first extruded hollow profile. Reduction of the cross-section may be accomplished by any method known to the skilled person, preferably by cold working such as hammering, pressing, roll forming, or drawing. It should be understood that deformation by both expansion and reduction of cross-section is also possible.

In a first embodiment of the method, the method relates to the manufacture of a flat shaped coaxial dual core HV cable. The method for manufacturing the flat shaped cable may involve using extruded first and second profiles having a generally oblong or oval, or flattened oval (stadium shape), cross-sectional shape. The assembly of the extruded profiles may be performed as explained above. Another method for manufacturing a flat shaped coaxial dual core HV cable may comprise assembling extruded profiles as explained above, whereafter the assembly is subjected to a flattening deformation. In this method it is preferred that the second extruded profile, constituting the inner conductor, is a hollow profile, such as a tube. Upon the flattening deformation, the inner hollow profile (inner conductor) will be pressed flat, obtaining a strip-like shape, while the outer conductor is encompassing the inner conductor, and the first electrically insulating layer is kept in place during the flattening process. The flattening may be obtained by rolling, pressing, drawing or any other suitable method known to the skilled person. An insulating layer/sheath can be applied on the outer surface of the outer conductor before or after the flattening of the conductor assembly.

In second embodiment of the method, n the method further comprises
(a) providing at least one cooling channel where the at least cooling channel is one or more extruded metal tube;
(b) applying a coating layer of a third electrically insulating material onto the outer surface of the at least one cooling channel, to obtain at least one coated cooling channel; and
(c) placing the at least one coated cooling channel inside the longitudinal void of the second extruded hollow tube and either
   expanding the at least one coated cooling channel until the third electrically insulating layer on the outer surface of the at least one cooling channel is contacting and fully covering the inner surface of the hollow void of the second extruded tube, or
   reducing the cross-section of the second extruded tube until the third electrically insulating layer on the outer surface of the at least one cooling channel is contacting and fully covering the inner surface of the hollow void of the second extruded tube, or a combination of both expanding and reducing the cross-section.

The at least one cooling channel is preferably an extruded tube of aluminium or aluminium alloy.

Advantageously, the at least one coated cooling channel is assembled with the inner conductor by expanding the cooling channel. The expansion may e.g. be performed by plug drawing or hydroforming.

Furthermore, the second embodiment of the method involves placing the assembly of the inner conductor with the at least one cooling channel in the longitudinal hollow of the first extruded profile (outer conductor) and reducing the cross-section of the outer conductor until the inner surface of the hollow void is contacting and fully covered by the first electrically insulating layer on the outer surface of the inner conductor.

### Example Embodiments

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person. It should be understood that dimensions and size ratios in the drawings are only illustrative and should not be construed as limiting.

In the drawings, like reference numerals refer to like parts through all the various figures unless otherwise specified.

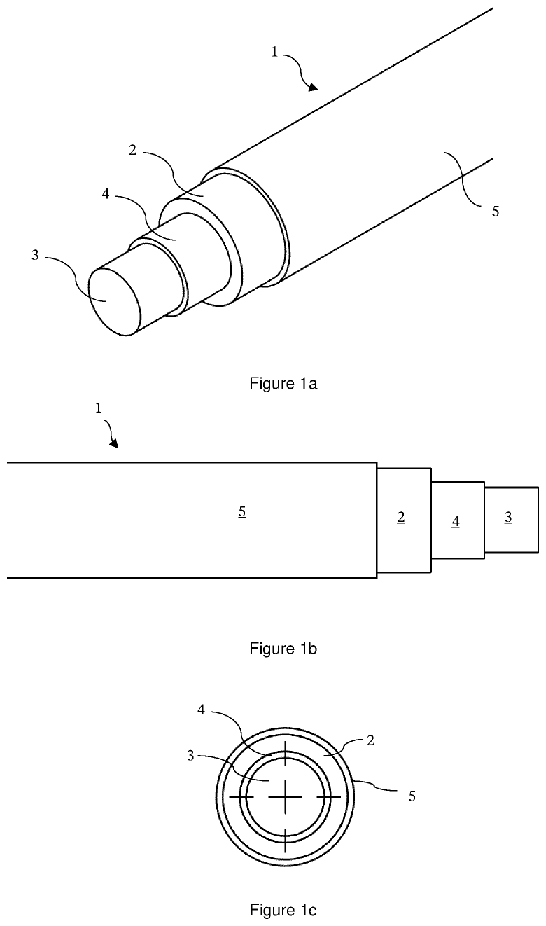

FIGS. 1a-c shows a coaxial dual core HV cable 1 comprising an outer hollow conductor 2, an inner conductor 3 arranged inside the hollow outer conductor 2, and a first electrically insulating layer 4 is arranged between the inner conductor 3 and the hollow outer conductor 2, wherein the first electrically insulating layer 4 is in direct contact with the entire outer surface of the inner conductor 3 and the entire inner surface of the hollow outer conductor tube 2. In the illustrated example, the cable includes a second electrically insulating layer 5 arranged on the outside surface of the hollow outer conductor 2. For illustration purposes, each layer of the cable are cut away in FIGS. 1a and 1b. FIG. 1c shows the cross-section of the cable, illustrating a solid core conductor 3 coaxially arranged inside the outer hollow conductor 2, and the first insulating layer 4 arranged between the inner and outer conductors. The outer surface of the outer conductor 2 has a sheath layer of an electrically insulating layer 5.

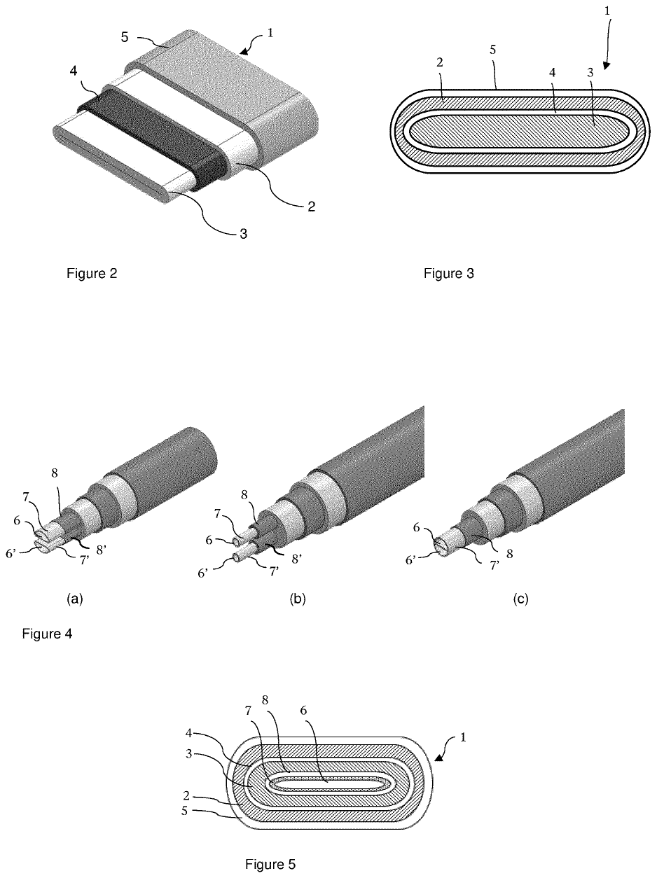

FIG. 2 shows a perspective view of a flat formed coaxial dual core HV cable 1 comprising an outer hollow conductor 2, an inner conductor 3 arranged inside the hollow outer conductor 2, and a first electrically insulating layer 4 is arranged between the inner conductor 3 and the hollow outer conductor 2, wherein the first electrically insulating layer 4 is in direct contact with the entire outer surface of the inner conductor 3 and the entire inner surface of the hollow outer conductor tube 2. In the illustrated example, the cable includes a second electrically insulating layer 5 arranged on the outside surface of the hollow outer conductor 2. The outer conductor 2 and the inner conductor 3 are made of extruded metal tubes, assembled as explained above, and thereafter subjected to a flattening process until the inner tube is completely flattened. The first electrically insulating layer 4 is maintained in direct contact with the entire outer surface of the inner conductor 3 and the entire inner surface of the hollow outer conductor tube 2 after the tube assembly has been flattened. For illustration purposes, each layer of the cable are cut away. The flat cable 1 has a high surface area which leads to an enhanced cooling effect compared to a non-flat cable. In addition, the flat cable has a lower height in comparison to round shapes with equal cross-section area.

FIG. 3 shows an alternative cross-section shape of a flat coaxial dual core HV cable 1 where the inner conductor 3 is a solid extruded profile.

FIG. 4a-c shows perspective views of different example embodiments of the coaxial dual core HV cable 1 having internal cooling channels 6, 6′. The cable 1 comprises, correspondingly to the cable in FIG. 1, an outer hollow conductor 2, and an inner hollow conductor 3 arranged inside the hollow outer conductor 2, and a first electrically insulating layer 4 is arranged between the inner conductor 3 and the hollow outer conductor 2, wherein the first electrically insulating layer 4 is in direct contact with the entire outer surface of the inner conductor 3 and the entire inner surface of the hollow outer conductor tube 2. In the illustrated example, the cable includes a second electrically insulating layer 5 arranged on the outside surface of the hollow outer conductor 2. FIG. 4a illustrates a coaxial dual core HV cable 1 wherein the inner conductor comprises two separated D-shaped hollows running the whole length of the cable 1. Each of the D-shaped ports has a D-shaped cooling tube 7, 7′ arranged therein forming two separate cooling channels 6, 6′ used for flow and return flow for cooling medium. A third electrically insulating layer 8, 8′ is arranged between the inner conductor 3 and the cooling tubes 7, 7′, wherein the third electrically insulating layer 8, 8′ is in direct contact with the entire outer surface of the cooling tubes 7, 7′ and the entire inner surface of the hollows of the inner conductor tube 3. FIG. 4b shows a corresponding cable as in FIG. 4a, where the cooling tubes 7, 7′ are round tubes, and correspondingly, the ports in the inner conductor 3 are round. FIG. 4c illustrates a single round cooling tube 7 which is separated into two cooling channels 6, 6′ by an internal wall, thus each cooling channel has a D-shape. Correspondingly the hollow in the inner conductor has a round shape. In each of the examples shown in FIG. 4a-c the cooling tubes 7,7′ are made of metal, preferably extruded aluminium tubes.

FIG. 5 shows an alternative cross-section of a flat formed coaxial dual core HV cable 1 having an internal cooling channel. A flattened form of the cable 1 which also comprises internal cooling channel will have an efficient cooling both from the outside, due to the increased surface area, and the inside, due to active cooling.

1. A coaxial dual core high-voltage (HV) cable (1), comprising
a first extruded, elongated hollow profile of an electrically conducting metal, forming a first conductor (2);
a second extruded, elongated profile of an electrically conducting metal, forming a second conductor (3), the second conductor (3) being arranged coaxially inside the first conductor (2);
a first electrically insulating layer (4) arranged between the first conductor (2) and the second conductor (3), and coating an outer surface of the second conductor (3) and an inner surface the first conductor (2); and
a second electrically insulating layer (5) coating an outer surface of the first conductor (2).

2. The coaxial dual core HV cable (1), according to claim 1, where the second conductor (3) is a solid rod, or a hollow profile having at least one void throughout its total length.

3. The coaxial dual core HV cable (1), according to claim 1, where the cable (1) has a cross-sectional shape selected from circular, rounded, oval, flattened oval (stadium shaped), rectangular, oblong, quadratic, or polygonal.

4. The coaxial dual core HV cable (1), according to claim 2, wherein the cable (1) has a flat cross-sectional shape and the first electrically insulting layer (4) arranged between the first conductor (2) and the second conductor (3) is in direct contact with the outer surface of the second conductor (3) and an inner surface the first conductor (2) and has a substantially uniform thickness.

5. The coaxial dual core HV cable (1), according to claim 1, further comprising at least one cooling channel (6, 6′) for flow of a cooling medium, the at least one cooling channel (6, 6′) being an extruded metal tube (7, 7′) coaxially arranged inside the at least one void of the second conductor (3), and having a third electrically insulating layer (8, 8′) arranged between an outer surface of the at least one cooling tube (7, 7′) and an inner surface of the at least one void of the second conductor (3).

6. The coaxial dual core HV cable (1), according to claim 5, comprising two cooling channels (6,6′); the cooling channels (6, 6′) being
a first cooling channel (6, 6′) for flow of a cooling medium, and
a second cooling channel (6, 6′) for a return flow of the cooling medium.

7. The coaxial dual core HV cable (1), according to claim 6, wherein the two cooling channels (6,6′) are formed by a single extruded cooling tube (7) with two parallel channels extending in an axial direction.

8. The coaxial dual core HV cable (1), according to claim 6, wherein the two cooling channels are formed by two separate extruded tubes (7, 7′) extending in an axial direction.

9. The coaxial dual core HV cable (1), according to claim 1, wherein the first conductor (2) and the second conductor (3) and the at least one cooling tube(s) (7, 7′) are made of a metal chosen from aluminium, aluminium alloy, copper or copper alloy.

10. The coaxial dual core HV cable (1), according to claim 9, wherein the first conductor (2) and/or the second conductor (3) are made of an AA6XXX-series alloy or an AA1XXX-series alloy.

11. The coaxial dual core HV cable (1), according to claim 1, wherein the material of the first electrically insulating layer, and/or the second electrically insulating layer, and/or the third electrically insulating layer has a dielectric strength of 30-70 kV/mm.

12. The coaxial dual core HV cable (1), according to claim 1, wherein the material of the second electrically insulating layer has a dielectric strength of 15-30 kV/mm.

13. A method for manufacturing a coaxial dual core high-voltage cable (1), according to claim 1, the method comprises the following steps:
(i) providing a first extruded hollow profile (2) of an electrically conducting metal, and a second extruded profile (3) of an electrically conducting metal, the second extruded profile (3) having a diameter which is smaller than the internal diameter of the hollow of the first extruded hollow profile (2), and the second extruded profile (3) is either a solid rod, or a hollow profile having at least one void throughout its total length;
(ii) applying a coating layer of a first electrically insulating material (4) onto an outer surface of the second extruded profile (3), to obtain a coated second extruded profile having a first electrically insulating layer (4);
(iii) assembling the first extruded hollow profile (2) and the second extruded profile (3) by placing the coated second extruded profile (3) inside the first extruded hollow profile (2) and
(a) expanding the coated second extruded tube (3) until the first electrically insulating layer (4) is directly contacting and covering the inner surface of the first extruded hollow profile (2), or
(b) reducing the diameter of the cross-section of the first extruded hollow profile (2) until the first electrically insulating layer (4) is directly contacting and covering the inner surface of the first extruded hollow profile (2), or
(c) a combination of both (a) and (b);
(iv) applying a coating layer (5) of a second electrically insulating material onto an outer surface of the first extruded hollow profile (2).

14. The method according to claim 13, wherein the step of applying the second electrically insulating layer (5) is performed before or after step (iii).

15. The method according to claim 13, further comprising,
providing at least one cooling tube (7, 7′), the at least one cooling tube being an extruded metal tube;
applying a coating layer of a third electrically insulating material (8) onto an outer surface of the at least one cooling tube (7, 7′), to obtain at least one coated cooling tube (7, 7′);
placing the at least one coated cooling tube (7, 7′) inside the second extruded hollow profile (3) having at least one void, and performing one or both of
expanding the at least one coated cooling tube (7, 7′) until the third electrically insulating layer (8) on the outer surface of the at least one cooling tube is in direct contact with and covering the inner surface of the void of the second extruded hollow profile (3), or
reducing the diameter of the cross-section of the second extruded hollow profile (3) until the third electrically insulating layer (8) on the outer surface of the at least one cooling tube (7, 7′) is in direct contact with and covering the inner surface of the void of the second extruded hollow profile (3).

16. The method according to claim 13, further comprising flattening of the cable (1).

17. The method according to claim 13, wherein the first extruded hollow profile (2), the second extruded profile (3), and the at least one cooling tube (7,7′) are made of a metal chosen from aluminium, aluminium alloy, copper or copper alloy, preferably from aluminium or aluminium alloy.

18. Use of a coaxial dual core high-voltage (HV) cable (1) according to claim 1, for electric power transmission at high voltage in a hybrid electric vehicle (HEV), or in an electric vehicle (EV), or as a charging cable in a charging unit or a charging station, or in charging station infrastructure, or in an electrical vessel or hybrid electrical vessel, or in a data centre, or in windmills or windmill parks, or in PV systems.
